(19) United States
(12) Patent Application Publication
(10) Pub. No.: US 2022/0201145 A1
(43) Pub. Date: Jun. 23, 2022

(54) PROVIDING APPLICATION CONFIGURATION FILE FOR BACKWARD COMPATIBLE APPLICATION

(71) Applicant: HEWLETT-PACKARD DEVELOPMENT COMPANY, L.P., Spring, TX (US)

(72) Inventors: Giwon SEO, Seongnam-si (KR); Yeonjung LIM, Seongnam-si (KR); Jeongho KIM, Seongnam-si (KR)

(73) Assignee: HEWLETT-PACKARD DEVELOPMENT COMPANY, L.P., Spring, TX (US)

(21) Appl. No.: 17/606,674

(22) PCT Filed: May 21, 2020
(86) PCT No.: PCT/US2020/033986

§ 371 Date: Oct. 26, 2021

(30) Foreign Application Priority Data
Dec. 4, 2019 (KR) 10-2019-0159636

(51) Int. Cl. H04N 1/00; G06F 8/71; G06F 8/658

(52) U.S. Cl. CPC H04N 1/00938; G06F 8/658; G06F 8/71; H04N 1/00204

(57) ABSTRACT

An example server includes a processor to receive a first version configuration value to be applied to a first version of an application from a user terminal, determine at least one device to which the configuration value is to be distributed, and identify an application version installed in the at least one device. The server converts the first version configuration value to a second version configuration value to be applied to a second version of the application by using a conversion rule, when a device in which the second version of the application different from the first version of the application is installed is identified, and transmits a configuration file including the second version configuration value to the device in which the second version of the application is installed. Here, the conversion rule includes relationship information between the first version configuration value and the second version configuration value.

### BACKGROUND

An application center may distribute, install, or delete an application registered by a developer to a remote device. When an application installed in the device is executed, the device reads and applies a configuration file of the application. For example, if the device is a printer, the configuration file may include a print option, a scan option, and the like.

### BRIEF DESCRIPTION OF THE DRAWINGS

Various examples will be described by referring to the accompanying drawings.

FIG. 1 illustrates a system for providing an application configuration file compatible with an application version according to an example.

FIG. 2 illustrates a process for providing an application configuration file compatible with an application version according to an example.

FIG. 3 illustrates a system for providing an application configuration file compatible with an application version according to an example.

FIG. 4 illustrates a registration user interface (UI) of an application configuration file according to an example.

FIG. 5 illustrates a UI for setting a distribution target of an application configuration file according to an example.

FIG. 6 illustrates an edit UI of an application configuration file according to an example.

FIG. 7 illustrates a process for providing an application configuration file compatible with an application version according to an example.

FIG. 8 illustrates a process for providing an application configuration file compatible with an application version according to an example.

FIG. 9 illustrates an application center according to an example.

### DETAILED DESCRIPTION

As those skilled in the art will realize, the following described examples may be modified in various different ways, all without departing from the spirit or scope of the present disclosure. In order to clarify the present disclosure, parts that are not relevant to the description will be omitted, and the same elements or equivalents are referred to by the same reference numerals throughout the specification.

Throughout the specification, when a part is referred to “include” a certain element, it means that it may further include other elements rather than exclude other elements, unless specifically indicates otherwise.

In addition, term such as “ . . . unit”, “ . . . block”, “ . . . module”, and the like described in the specification refer to a unit that processes at least one function or operation, which may be implemented with hardware, software, or a combination thereof.

The apparatus described in the present disclosure may be implemented with hardware including at least one processor, a memory device, a communication device, and the like, and a program executed in combination with the hardware may be stored in a designated location. The hardware has a configuration and performance to implement the example methods of the present disclosure. The program includes instructions implementing the example operation methods of the present disclosure described with reference to accompanying drawings, and executes the example methods of the present disclosure in combination with hardware such as a processor, a memory device, and the like.

As used herein, the term “transmit or provide” may be used to include not only direct transmission or provision but also indirect transmission or provision via another device or a bypass.

The singular forms “a”, “an”, and “the” are intended to include the plural forms as well, unless the explicit expression such as “one” or “singular” is used.

The expression “and/or” may include each of the referred elements and every combination of one or more thereof.

In the present specification, terms including ordinal numbers such as first, second, and the like may be used to describe various elements, but the elements are not limited by the terms. The terms are used only for the purpose of distinguishing one element from another. For example, without departing from the scope of the present disclosure, a first element may be referred to as a second element, and similarly the second element may be referred to as the first element.

In a flowchart described with reference to the accompanying drawings, the operation order may be changed, several operations may be merged, a certain operation may be divided, and a specific operation may not be executed.

In the present specification, an application accomplishes a specific purpose or function by being installed and executed in a device. According to an example, the application may include a program that addresses a software problem or a hardware problem of the device

To set the same application configuration value to a plurality of devices owned by a client company, an information technology (IT) administrator or a reseller may reiterate a process of accessing the device, executing the application, and editing the application configuration values for each device.

However, with a function of Remote Config, the IT administrator or the reseller may remotely edit the application configuration value. This function of Remote Config is provided through an application management and distribution portal.

By using a configuration value template described herein, an application management and distribution portal may provide a list of options that the IT administrator or the reseller may edit and values that may be input for each option through a user interface (UI), such as a web based UI. Using the application management and distribution portal, the IT administrator or the reseller can apply the application configuration value to a plurality of devices in a single edit.

When an application is updated, there is no compatibility issue between versions, since the structure of the application configuration value is basically not changed. However, there may be a case in which an internal structure of the application configuration value is changed to a structure readable by the updated application. In such a case, the IT administrator or the reseller edits the application configuration value to values that the updated application can read. That is, an application configuration template including a list of options that can be designated in each application and value information that can be input for each option is also updated. Therefore, the configuration value input by the IT administrator or the reseller based on the updated application configuration template is generated in an updated format.

When the updated application configuration value is distributed, the distributed application configuration value may be applied to a device in which the updated application is installed, but may not be applied to a device in which a previous version of the application is installed. That is, since the structure of the configuration value of the application installed in the device is different from that of the distributed application configuration value due to the change on the internal structure of the application configuration value, a compatibility issue in which the application installed in the device cannot read the application configuration value is caused. In that case, the application reads only readable values and ignores unreadable values.

The application management and distribution portal may not distribute the application configuration value to a device that has a different version of the application from that of the application configuration value. Alternatively, the version of the application in the device may be enforcedly upgraded or guided to that of the application configuration value, or to the latest version. However, such a method may impede the process of applying the application configuration value to all of the devices.

To address such a compatibility issue, various examples include a configuration value of an application that is generated and distributed for each version of the application installed in devices. Even if the IT administrator or the reseller edits the configuration value of the updated application only once, since the configuration value is converted for each version of the application and transmitted, the application configuration value may be distributed without any compatibility issue.

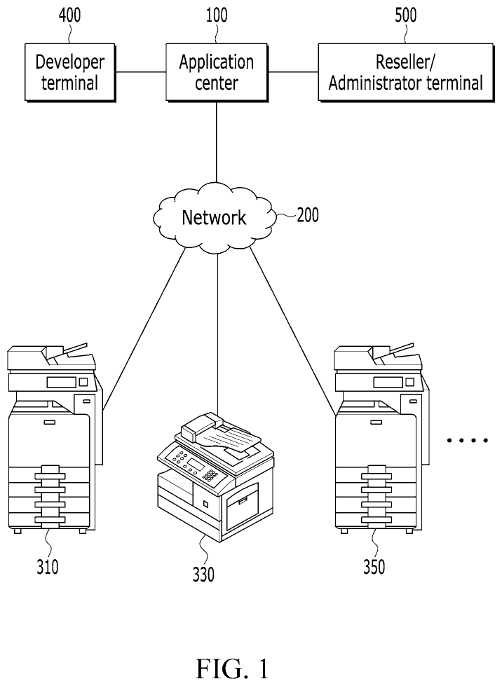

FIG. 1 illustrates a system for providing an application configuration file compatible with an application version according to an example.

Referring to FIG. 1, an application center 100 is connected to devices 310, 330, and 350 via a network 200. The application center 100 is connected to a user terminal, such as a developer terminal 400 and a reseller/administrator terminal 500.

Each of the application center 100 and the devices 310, 330, and 350 is implemented as a computing device including a memory and at least one processor. The processor executes instructions of a program loaded in the memory.

The application center 100 may be implemented as a cloud server.

The devices 310, 330, and 350 may include an image forming apparatus that generates, prints, receives, and transmits image data. The image forming apparatus may be a printer, a scanner, a copy machine, a fax machine, a multifunction printer integrating the functions thereof, and the like.

The application center 100 may install a newly developed application or an updated application in one or more of the remote devices 310, 330, and 350, or delete an application from one or more of the devices 310, 330, and 350.

The application center 100 may distribute a configuration file of an application edited by an IT administrator or a reseller to devices 310, 330, and 350. The configuration file can be edited through an application management and distribution portal operated by the application center 100.

The devices 310, 330, 350 may include system services for authentication, application execution, and application management, and may install and execute various applications.

The devices 310, 330, and 350 may install and execute applications distributed by the application center 100. The devices 310, 330, and 350 read the configuration file included in the distributed application or the configuration file received from the application center 100 to apply the configuration file to the executed application.

The devices 310, 330, and 350 may include applications and a configuration manager. The application reads configuration values designated in the configuration file and applies them to an execution environment. The configuration manager may receive an application configuration file and deliver the configuration values designated in the application configuration file to the application when each application is executed. When the IT administrator or the reseller executes the application and edits the configuration value, the application configuration file including the edited configuration values may be stored.

When a remote call is generated from the application center 100, the configuration manager may provide the stored application configuration file to a configuration editor. When the IT administrator or the reseller wants to remotely read the application configuration file designated for the application, the configuration manager may provide the application configuration file.

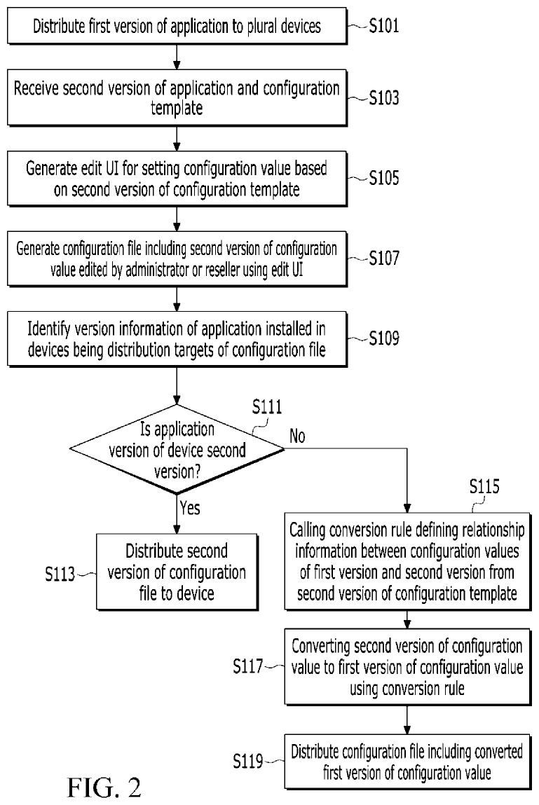

FIG. 2 illustrates a process for providing an application configuration file compatible with an application version according to an example.

Referring to FIG. 2, the application center 100 distributes a first version of an application to the devices 310, 330, and 350 in operation S101.

The application center 100 receives an updated second version of the application and a configuration template from the developer terminal 400 in operation S103. In the following example, it is assumed that the second version of the application is more recent than the first version of the application.

The application center 100 generates an edit UI for setting configuration values that are generated based on the second version of the configuration template in operation S105.

The application center 100 generates a configuration file including the second version of the configuration values edited by the reseller/manager terminal 500 using the edit UI in operation S107.

The application center 100 identifies version information of the application installed in each of the devices 310, 330, and 350 that are distribution targets of the configuration file in operation S109.

The application center 100 determines whether the version of the application installed in each of the devices 310, 330, and 350 is the second version in operation S111.

When it is determined that each of the devices 310, 330, and 350 has the second version of the application in operation S111, the application center 100 distributes the second version of the configuration file to each of the devices 310, 330, and 350 in operation S113.

When it is determined that one or more of the devices 310, 330, and 350 do not have the second version of the application at operation S111, the application center 100 calls a conversion rule from the second version of the configuration template in operation S115. Here, in the conversion rule, relationship information between the configuration values of the first version and the second version is defined.

The application center 100 converts the second version of the configuration value to the first version of the configuration value by using the conversion rule in operation S117. Here, the first version is the application version of the one or more of the devices 310, 330, and 350.

The application center 100 distributes a configuration file including the first version of the configuration value converted at operation S117, to the one or more of the devices 310, 330, and 350 in operation S119.

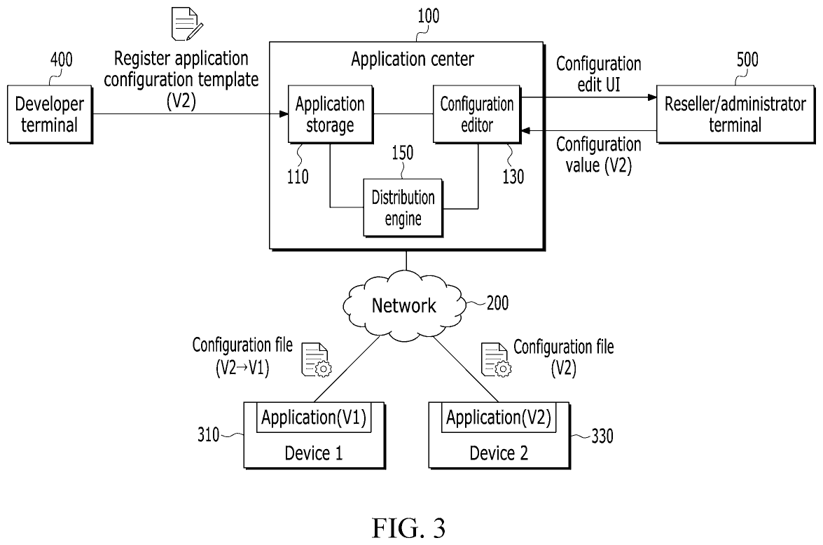

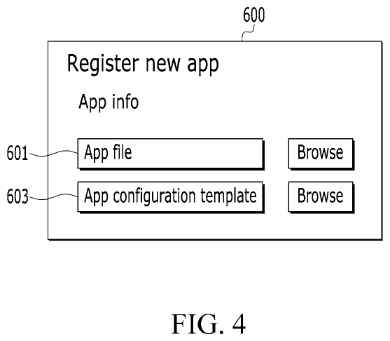

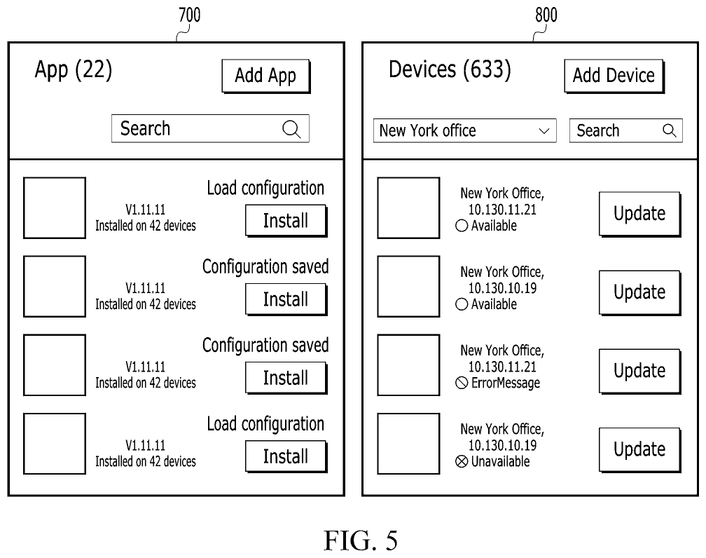

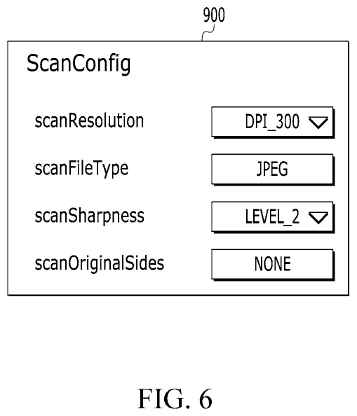

FIG. 3 illustrates a system for providing an application configuration file compatible with an application version according to an example. FIG. 4 illustrates a registration UI of an application configuration file according to an example. FIG. 5 illustrates a UI for setting a distribution target of an application configuration file according to an example. FIG. 6 illustrates an edit UI of an application configuration file according to an example.

Referring to FIG. 3, the application center 100 may include an application storage 110, a configuration editor 130, and a distribution engine 150.

The application storage 110, the configuration editor 130, and the distribution engine 150 may be implemented as hardware, software, or a combination thereof. Further, each of the application storage 110, the configuration editor 130, and the distribution engine 150 may be implemented as a separate individual server apparatus.

The developer terminal 400 registers an application and a configuration template of the application in the application storage 110. The developer terminal 400 may register an application configuration template along with a binary package of the application.

The application storage 110 may receive an application and a configuration template of the application through an application registration UI, an example of which is shown in FIG. 4.

Referring to FIG. 4, an application registration UI 600 includes an application file field 601 and an application configuration template field 603. The application storage 110 stores an application file uploaded to the application file field 601 and an application configuration template uploaded to the application configuration template field 603. The application registration UI 600 provides update registration as well as new registration.

The configuration template may be a kind of definition that defines a remote configuration (e.g., Remote Configuration, Remote Config) item for each of the devices 310, 330, and 350, a configuration value for each item, and the like.

The configuration template includes a list of options that can be set in each application and information that can be input for each option along with an identifier (ID) and key values. The configuration template may be defined to display an error after identifying a valid value of each option. The configuration template may be written in a format such as extensible markup language (XML), JavaScript object notation (JSON), and the like.

An IT administrator or a reseller may edit the configuration value of the application through the edit UI. The IT administrator or the reseller may be a user who manages accounts of the devices 310, 330, and 350 and provides a service such as application distribution, application support, and the like.

After an authentication operation, the IT administrator or the reseller may access the application management and distribution portal. The IT administrator or the reseller may install or delete an application in the devices 310, 330, and 350, and edit and distribute the configuration value of the application.

The configuration editor 130 may operate the application management and distribution portal. The configuration editor 130 may provide a remote configuration function of an application through the application management and distribution portal.

The configuration editor 130 may provide an edit UI for remote configuration for the devices 310, 330, and 350 through the application management and distribution portal. The configuration editor 130 may generate an edit UI using a configuration template of the application. For example, the edit UI may consist of a configuration value item that can be input for each application, such as a scan option, a print option, a basic path, and the like.

The configuration editor 130 may receive an application that is selected or input to be distributed by the IT administrator or the reseller, and information on devices that are targets of the application distribution through the edit UI, an example of which is shown in FIG. 5

Referring to FIG. 5, the edit UI includes an application UI 700 and a device UI 800. The application UI 700 may display an application list showing applications registered in the application storage 110, and display an installation request button, an installation progress status, an application version, and the like for each application.

The device UI 800 may display a device list showing devices 310, 330, and 350 connected to the network 200, and display a distribution request button for each device. Here, an individual device may be displayed in the device list. Alternatively, the device list may be displayed based on a group, such as a region, an organization, or the like.

When the IT administrator or the reseller clicks the installation request button of a certain application in the application UI 700, the configuration editor 130 may provide an edit UI of the application configuration file, an example of which is shown in FIG. 6.

Based on a configuration template of the application for which the installation request button is clicked, the configuration editor 130 may generate the edit UI, an example of which is shown in FIG. 6.

Referring to FIG. 6, an edit UI 900 may provide a configuration item defined in the configuration template and a field for selecting or inputting the configuration value for each configuration item. For example, when the devices 310, 330, and 350 are image forming apparatuses such as printers and the like, the configuration item may be defined as a scan option. Each scan option may include ‘scanResolution’, ‘scanFileType’, ‘scanSharpness’, ‘scanOriginalSides’, and the like. In this case, the application configuration file may consist of scan option configuration values.

The configuration editor 130 may provide an application configuration file that is composed of an application for which the installation request button is clicked in the application UI 700 shown in FIG. 5, the device for which the distribution request button is clicked in the device UI 800 shown in FIG. 5, and information input through the edit UI 900 shown in FIG. 6.

In an example, if the application configuration template is changed as the application is updated, an internal structure of the application configuration file may be changed. In this case, a device having a previous version of the application and a device having an updated version of the application may simultaneously exist among the devices 310, 330, and 350.

Here, if the edited application configuration file of the updated version is distributed, a compatibility problem in which the device having a previous version of an application cannot read the application configuration file may occur. In order to settle such a compatibility problem, the application configuration template includes a conversion rule that converts application configuration values of the updated version to those of the previous version. The conversion rule may be based on extensible stylesheet language transformations (XSLT) or a JSON based conversion tool.

When an application configuration template of version 2 is registered in the application storage 110, the configuration editor 130 provides a configuration edit UI generated based on the application configuration template of version 2 to the IT administrator or the reseller. The distribution engine 150 distributes an application configuration file of version 2 including application configuration values input through the configuration edit UI to the devices 310, 330, and 350.

When an application of version 1 is installed in the device 1 (310) and an application of version 2 is installed in the device 2 (330), the application of the device 1 310 cannot read an application configuration file (V2) having a new structure. Therefore, the configuration editor 130 converts the application configuration file of version 2 according to an application version of the target device by using previously known application version information of devices. If the version of the application installed in the device designated by the IT administrator or the reseller as a target of the application configuration file of version 2 is a previous version V1, the application configuration file of the new version V2 is converted into the previous version V1.

The configuration editor 130 may convert the application configuration file of the new version V2 as shown in Table 1 into the application configuration file of the previous version V1 as shown in Table 3, by using a conversion rule as shown in Table 2. The conversion rule shown in Table 2 may be included in the configuration template.

TABLE 1

```
{
  “result”: {
    “frames”: [
      “fidgets”: [
        {
          “id”: “ScanResolution”,
          “sets”: [
            {
              “items”: [
                {
                  “value”: “true”,
                  “key”: “DPI_300”
                }
              ],
              “key”: “scanResolution”
            }
          ]
        },
        {
          “id”: “scanFileType”,
          “sets”: [
            {
              “items”: [
                {
                  “value”: “true”,
                  “key”: “MTIFF”
                }
              ],
              “key”: “scanFileType”
            }
          ]
        }
      ]
    }
  }
}
```

TABLE 2

```
{
  “scanConfig” : {for (.result.frames.fidgets)
    .id : .sets.items.key
  }
}
```

TABLE 3

```
{
  “scanConfig” : {
    “scanResolution” : “DPI_300”,
    “scanFileType” : “MTIFF”
  }
}
```

Referring to Table 1, the ‘id’ set in the ‘fidgets’ object that is written below the ‘frames’ item below the ‘result’ item has two types of ‘scanResolution’ and ‘scanFileType’. For each of the two types of ‘id’, a value set for ‘key’ below the ‘items’ item below the ‘sets’ item is ‘DPI_300’ and ‘MTIFF’, respectively.

Referring to Table 2, the ‘scanConfig’ option is defined to designate a ‘key’ value for each ‘id’ set in the ‘fidgets’ object shown in FIG. 1.

Therefore, by using the conversion rule of Table 2, the ‘scanConfig’ option shown in Table 2 may be changed to the ‘scanConfig’ option having a structure shown in Table 3.

Further, the configuration editor 130 may be requested to duplicate the application configuration of the device 1 310 to the device 2 330 through the edit UIs. When the device 2 330 is newly added, the duplication function may make the application configuration file to be designated, with only duplicating the application configuration file previously set in the device 1 310.

Alternatively, when the IT administrator or the reseller wants to change the application configuration file of the device 2 330, the application configuration file may be easily changed by the duplication function. In this case, if the device 2 330 is a device in which the previous version of the application is installed, a change to the previous version of the application configuration file is performed in the same manner as described above.

The distribution engine 150 distributes applications registered in the application storage 110 to the devices 310, 330, and 350 via the network 200.

In this case, the distribution engine 150 may distribute, to the devices 310, 330, and 350, the application configuration file edited by the configuration editor 130 before distribution of the application along with the application via the network 200.

Alternatively, after distributing the application, the distribution engine 150 may distribute the application configuration file edited by the configuration editor 130 to the devices 310, 330, and 350 via the network 200.

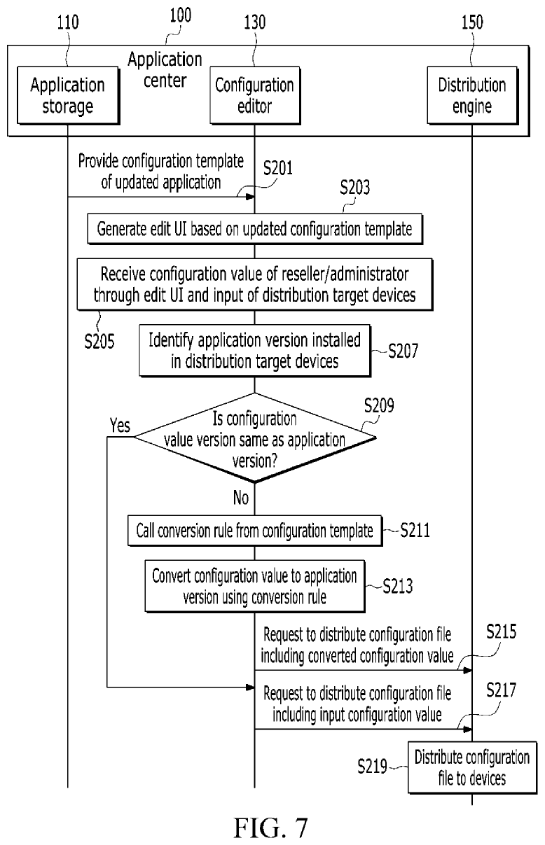

FIG. 7 illustrates a process for providing an application configuration file compatible with an application version according to an example.

Referring to FIG. 7, it is assumed that a first application V1 has been distributed to the devices 310, 330, and 350. The distributed application V1 includes a configuration file V1, and each of devices 310, 330, and 350 executes the application by applying the application configuration file.

In operation S201, the configuration editor 130 receives an updated configuration template from an application storage 110. The configuration editor 130 generates an edit UI based on the configuration template in operation S203.

The configuration editor 130 receives a configuration value input by an IT administrator or a reseller through the edit UI in operation S205.

The configuration editor 130 identifies application versions of devices that are selected as distribution target devices by the IT administrator or the reseller through the edit UI in operation S207.

The configuration editor 130 determines whether the version of the configuration template is the same as those of the selected devices in operation S209.

If it is determined that the versions of the configuration template and the selected devices are not the same in operation S209, the configuration editor 130 calls a conversion rule from the configuration template in operation S211. The configuration editor 130 converts the configuration value to the version of the application of the device by using the conversion rule in operation S213.

The configuration editor 130 requests the distribution engine 150 to distribute the converted configuration value in operation S215.

If it is determined that the versions of the configuration template and the selected devices are the same in operation S209, the configuration editor 130 requests the distribution engine 150 to distribute the configuration value input by the IT administrator or the reseller in operation S217.

The distribution engine 150 distributes the configuration value requested in operation S215 or in operation S217 to the target devices in operation S219. Though it is described that the configuration value is distributed, since the configuration value is distributed in a unit known as a file, the configuration value and the configuration file may be used as having the same meaning.

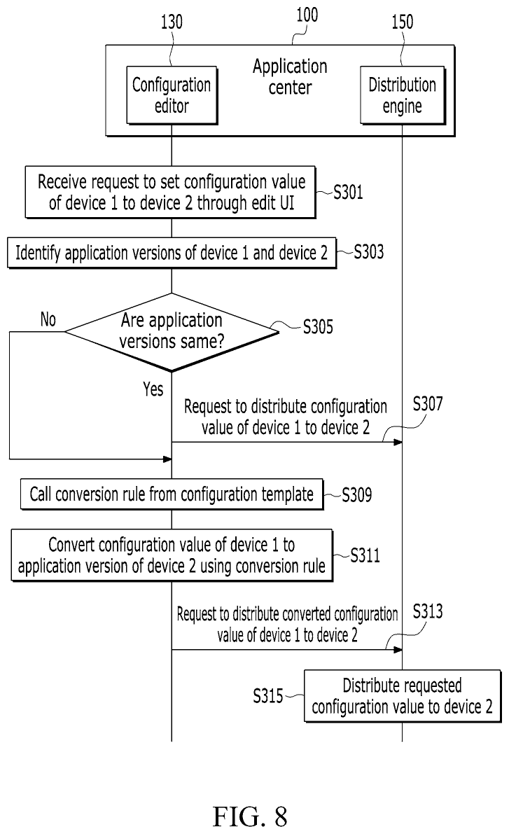

In FIG. 7, an example process in which the configuration template is updated is described. However, even when the application configuration value of a first device is set to a second device, the example of the present disclosure may be used. Hereinafter, an example of such a case will be described with reference to FIG. 8.

FIG. 8 illustrates a process for providing an application configuration file compatible with an application version according to an example.

Referring to FIG. 8, a configuration editor 130 may be requested to set an application configuration value of device 1 to device 2 through an edit UI in operation S301.

The configuration editor 130 identifies versions of applications installed in each of device 1 and device 2 in operation S303.

The configuration editor 130 determines whether the application versions identified in operation S303 are the same as each other in operation S305.

If it is determined that the versions are the same in operation S305, the configuration editor 130 requests the distribution engine 150 to distribute the application configuration value of the device 1 to the device 2 in operation S307.

If it is determined that the versions are not the same in operation S305, the configuration editor 130 calls a conversion rule from the configuration template installed in the device 1 in operation S309.

In operation S311, the configuration editor 130 converts the configuration value of the device 1 to the application version of the device 2 by using the conversion rule called in operation S309.

In operation S313, the configuration editor 130 requests the distribution engine 150 to distribute the converted configuration value of the device 1, converted in operation S311, to the device 2.

The distribution engine 150 distributes the configuration value requested in operation S307 or in operation S313 to the device 2 in operation S315. Though it is described that the configuration value is distributed, since the configuration value is distributed in a unit known as a file, the configuration value and the configuration file may be used as having the same meaning.

In an example, when distributing a configuration value through a remote configuration function of an application management and distribution portal, the application configuration value may be distributed without identifying a version of the application installed in the device in advance. If configuration values of applications of both new and previous versions are generated and distributed in a package, the application ignores an unreadable configuration value. Thus, even if the application configuration values of the new and previous versions are distributed in a package, the configuration value of each application version can be read.

That is, as described above with reference to FIG. 1 to FIG. 8, when the application is updated from the first version to the second version, the application center 100 determines whether there is an application of a previous version that is distributed before the second version. If it is determined that there is a first version of the application distributed before a second version, the second configuration value for the second version of the application is converted into a first configuration value for the first version of the application. Further, a configuration file including both the first configuration value and the second configuration value may be generated and distributed to the devices. The devices read the configuration values readable by an application they have and apply the configuration values to the application. The device in which the first version of the application is installed ignores the second configuration value and applies the first configuration value. Otherwise, the device in which the second version of the application is installed ignores the first configuration value and applies the second configuration value.

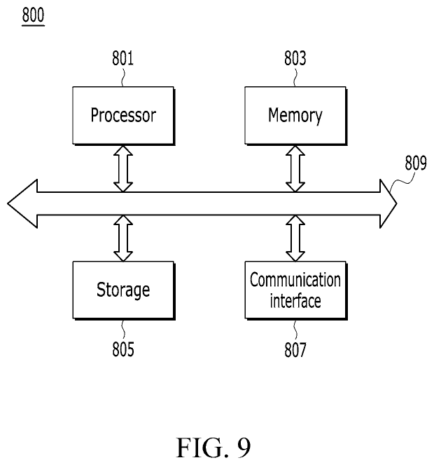

FIG. 9 illustrates a server apparatus according to an example.

Referring to FIG. 9, each of the application center 100, the configuration editor 130, and the distribution engine 150 above-described with reference to FIG. 1 to FIG. 8 may execute a program including instructions that is described to perform operations of the present disclosure in a server apparatus 800 driven by at least one processor.

Hardware of the server apparatus 800 may include at least one processor 801, a memory 803, a storage 805, a communication interface 807, and may be connected via a bus 809. Hardware such as an input device, an output device, and the like may be further included.

The server apparatus 800 may be equipped with a variety of software such as an operating system that can executes a program.

The processor 801 is a device for controlling operations of the server apparatus 800 and may include various types of processors for processing instructions included in a program. For example, the processor 801 may be a central processing unit (CPU), a micro processor unit (MPU), a micro controller unit (MCU), a graphic processing unit (GPU), and the like. The memory 803 may load the program such that the instructions described to perform example operations of the present disclosure are processed by the processor 801. The memory 803 may be, for example, a read only memory (ROM), a random access memory (RAM), and the like. The storage 805 may store various data, programs, and the like that are required to perform example operations of the present disclosure. The communication interface 807 may be a wired/wireless communication module.

As described above, according to the example, even if the configuration value structure is changed due to update of an application, since the configuration value of the updated application is converted to a configuration value structure of a previous version, a compatibility issue may be overcome. In addition, a configuration value may be simultaneously applied regardless of the versions of the applications installed in the devices, by editing the configuration value of the updated version by the IT administrator or the reseller.

The examples described above are not only implemented through the apparatus and the method as described but may be implemented through a program for performing a function corresponding to the configuration of the above-described examples or a recording medium on which the program is recorded.

Although the examples have been described above, the present disclosure is not limited thereto, and the present disclosure may be modified in various ways within the scope of the claims and the detailed description and accompanying drawings of the invention, which falls within the scope of the present disclosure.

What is claimed is:

1. A server apparatus comprising:
a memory; and
at least one processor that executes instructions of a program loaded in the memory,
wherein the processor executes the instructions to:
receive a first version configuration value to be applied to a first version of an application from a user terminal;
determine at least one device to which the configuration value is to be distributed and identify an application version installed in the at least one device;
convert the first version configuration value to a second version configuration value to be applied to a second version of the application by using a conversion rule, when a device in which the second version of the application different from the first version of the application is installed is identified; and
transmit a configuration file including the second version configuration value to the device where the second version of the application is installed, and
wherein the conversion rule includes relationship information between the first version configuration value and the second version configuration value.

2. The server apparatus of claim 1,
wherein the processor further executes the instructions to receive a configuration template defining information about configuration values to be applied to the first version of the application, before the receiving of the first version configuration value, and
wherein the first version configuration value includes a value that is selected by the user terminal from information defined in the configuration template.

3. The server apparatus of claim 2, wherein the configuration template includes the conversion rule.

4. The server apparatus of claim 2, wherein the receiving of the first version configuration value comprises:
generating a configuration value input display based on the configuration template;
providing the configuration value input display to the user terminal; and
receiving the first version configuration value that is input in the configuration value input display.

5. The server apparatus of claim 4, wherein the conversion rule defines conversion of data in an extensible stylesheet language transformation (XSLT) format or a javascript object notation (JSON) format.

6. The server apparatus of claim 1, wherein the second version of the application includes an application distributed prior to the first version of the application.

7. The server apparatus of claim 1, wherein, after the identifying of the application version, when a device in which the first version of the application is installed is identified among the at least one device, the processor further executes the instructions to transmit a configuration file including the first version configuration value to the device in which the first version of the application is installed.

8. A method of operating a server apparatus executed by at least one processor, the method comprising:
receiving a first configuration value to be applied to a first version of an application from a user terminal;
determining at least one device to which the configuration value is to be distributed;
converting the first configuration value to a second configuration value applied to a second version of the application by using a conversion rule, if a second version of the application distributed prior to the application of the first version exists; and
transmitting a configuration file including the first configuration value and the second configuration value to the at least one device,
wherein the conversion rule includes relationship information between the first configuration value and the second configuration value.

9. The method of claim 8, further comprising:
before the receiving of the first configuration value, receiving a configuration template defining information about configuration values to be applied to the first version of the application,
wherein the first configuration value includes a value that is selected by the user terminal from information defined in the configuration template, and
wherein the conversion rule is included in the configuration template.

10. The method of claim 9, wherein the receiving of the first configuration value comprises:
providing a user interface generated based on the configuration template to the user terminal; and
receiving the first configuration value input through the user interface.

11. The method of claim 9, further comprising determining whether the conversion rule is included in the configuration template, after determining the at least one device,
wherein the converting of the first version configuration value utilizes the conversion rule if it is determined that the conversion rule is included in the configuration template.

12. A method of operating a server apparatus executed by at least one processor, the method comprising:
receiving a request to set a first configuration value designated for a first device to at least one second device from a user terminal;
identifying version information of an application installed in the at least one second device; and
when a device in which a different version of an application from the application installed in the first device is identified among the at least one second device, transmitting a second configuration value converted from the first configuration value by using a conversion rule to the device in which the different version of the application is installed,
wherein the conversion rule includes relationship information defined between the first configuration value and the second configuration value.

13. The method of claim 12, further comprising, after the identifying of the version information, when a device in which a same version of the application as the application installed in the first device is identified among the at least one second device, transmitting the first configuration value to the device in which the same version of the application is installed.

14. The method of claim 12, further comprising, before the receiving of the request, receiving the first configuration value input from the user terminal through a user interface provided to the user terminal,
wherein the user interface is generated by using a configuration template, and
wherein the configuration template is a file in which information on configuration values to be applied to a version of the application installed in the first device is defined.

15. The method of claim 14, further comprising, before the receiving of the first configuration value, registering a second version of the application received form a developer terminal, after distribution and installation of a first version of the application to a plurality of devices,
wherein the second version of the application is an application installed in the first device and has a configuration value of different structure from that of the first version of the application.
